(19) United States
(12) Patent Application Publication
(10) Pub. No.: US 2026/0236963 A1
(43) Pub. Date: Aug. 13, 2026

(54) ADVERTISEMENT TRANSMISSION DEVICE, ADVERTISEMENT TRANSMISSION METHOD, AND RECORDING MEDIUM

(71) Applicant: NEC Corporation, Tokyo (JP)

(72) Inventor: Norikazu SHINPO, Tokyo (JP)

(73) Assignee: NEC Corporation, Tokyo (JP)

(21) Appl. No.: 19/154,913

(22) PCT Filed: Feb. 17, 2023
(86) PCT No.: PCT/JP2023/005780

§ 371 Date: Aug. 8, 2025

(51) Int. Cl. G06Q 30/0251

(52) U.S. Cl. CPC G06Q 30/0265; G06Q 30/0269

(57) ABSTRACT

This advertisement transmission device includes: one or more memories storing instructions; and one or more processors configured to execute the instructions to: acquire attribute information of a moving body detected from an image of a road targeted by a traffic light that displays a signal to moving bodies traveling on the road, said image being captured by said traffic light; acquire information indicating the lighting status of the traffic light; determine an advertisement to be transmitted to a terminal device of the moving body on the basis of the information indicating the lighting status of the traffic light and the attribute information; and output the determined advertisement to the terminal device of the moving body on the road targeted by the traffic light.

### TECHNICAL FIELD

The present disclosure relates to an advertisement transmission device, an advertisement transmission method, and a recording medium.

### BACKGROUND ART

It has been studied to use a traffic light installed on a road as an installation location of a base station of a 5th generation (5G) mobile communication system. It has been studied to provide various urban services such as traffic congestion mitigation, autonomous driving assistance, and information collection by equipping a traffic light with an imaging function and a communication function.

There is a technology for transmitting an advertisement to automobiles, bicycles, pedestrians, or the like traveling on a road.

PTL 1 describes a facility information delivery server that outputs facility information to be delivered and an order of the facility information according to positional information of a mobile terminal paired with a car or positional information of the car, and information indicating the type of car.

### CITATION LIST

### Patent Literature

PTL 1: JP 2018-146451 A

### SUMMARY OF INVENTION

### Technical Problem

However, the provided information may distract attention during traveling.

An object of the present disclosure is to provide a technology for appropriately transmitting an advertisement to people traveling on a road.

### Solution to Problem

According to an aspect of the present disclosure, there is provided an advertisement transmission device including: an attribute information acquisition means for acquiring attribute information of a moving body detected from an image of a road targeted by a traffic light that displays a signal to the moving body traveling on the road, the image being captured by the traffic light; a lighting state acquisition means for acquiring information indicating a lighting state of the traffic light; a determination means for determining an advertisement to be transmitted to a terminal device of the moving body based on the information indicating the lighting state of the traffic light and the attribute information; and an output means for outputting the determined advertisement to the terminal device of the moving body on the road targeted by the traffic light.

According to another aspect of the present disclosure, there is provided an advertisement transmission method including causing a computer to: acquire attribute information of a moving body detected from an image of a road targeted by a traffic light that displays a signal to the moving body traveling on the road, the image being captured by the traffic light; acquire information indicating a lighting state of the traffic light; determine an advertisement to be transmitted to a terminal device of the moving body based on the information indicating the lighting state of the traffic light and the attribute information; and output the determined advertisement to the terminal device of the moving body on the road targeted by the traffic light.

According to still another aspect of the present disclosure, there is provided a program that causes a computer to execute processing of: acquiring attribute information of a moving body detected from an image of a road targeted by a traffic light that displays a signal to the moving body traveling on the road, the image being captured by the traffic light; acquiring information indicating a lighting state of the traffic light; determining an advertisement to be transmitted to a terminal device of the moving body based on the information indicating the lighting state of the traffic light and the attribute information; and outputting the determined advertisement to the terminal device of the moving body on the road targeted by the traffic light.

The program may be stored in a non-transitory computer-readable recording medium.

### Advantageous Effects of Invention

An example of an effect in the present disclosure is to be able to appropriately transmit an advertisement to people traveling on a road.

### BRIEF DESCRIPTION OF DRAWINGS

FIG. 1 is a diagram illustrating a schematic example of processing in a system that implements an advertisement transmission device.

FIG. 2 is a diagram illustrating another schematic example of processing in a system that implements an advertisement transmission device.

FIG. 3 is a diagram illustrating an example of a use scene of an advertisement transmission device.

FIG. 4 is a block diagram illustrating a functional configuration of an advertisement transmission device according to a first example embodiment.

FIG. 5 is a diagram illustrating an example of an output screen.

FIG. 6 is a flowchart illustrating an operation of an advertisement transmission device according to the first example embodiment.

FIG. 7 is a block diagram illustrating a functional configuration of an advertisement transmission device according to a second example embodiment.

FIG. 8 is a flowchart illustrating an operation of an advertisement transmission device according to the second example embodiment.

FIG. 9 is a diagram illustrating a hardware configuration in which an advertisement transmission device according to the present disclosure is implemented by a computer device and its peripheral devices.

### EXAMPLE EMBODIMENT

The present disclosure relates to an advertisement transmission device and an advertisement transmission method that transmit an advertisement to a terminal device of a moving body traveling on a road, and a recording medium that records a program for causing a computer to execute the advertisement transmission. Here, the moving body is, for example, a car, a motorcycle, a bicycle, or a pedestrian, and is not limited thereto.

The terminal device of the moving body is a terminal device carried by an occupant of the moving body, a terminal device provided in the moving body, or a terminal device carried by a pedestrian who is the moving body. The terminal device of the moving body may be, for example, a smartphone, a tablet, smart glasses, or a car navigation device, but is not limited thereto. The occupant of the moving body is a person on a vehicle such as a car, a motorcycle, or a bicycle which is the moving body. The pedestrian is a person who travels on a road by a method not depending on a vehicle, and may include, for example, a person who is walking, a person who is using a wheelchair, and a person who is running. The pedestrian may include a person who is temporarily stopped while traveling on the road.

Next, a system including the advertisement transmission device of the present disclosure will be described. Each specific processing will be described later.

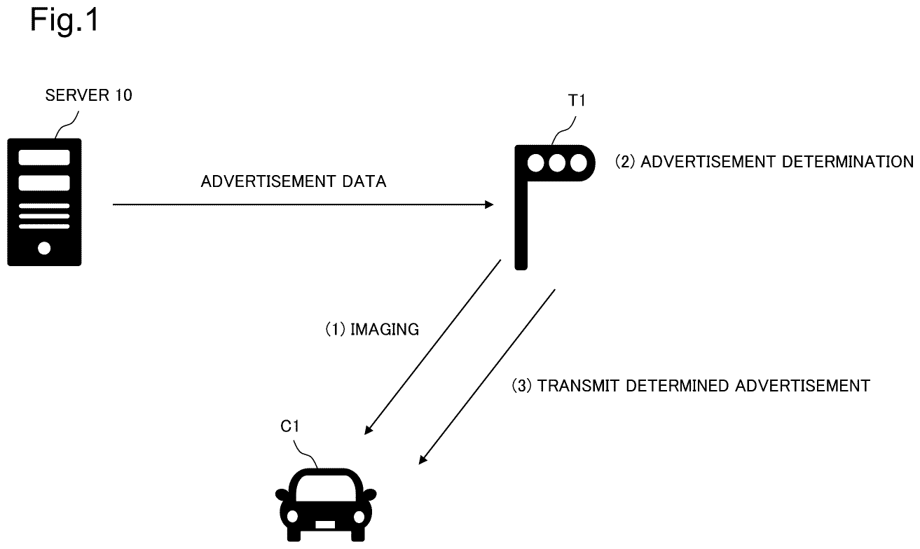

First, FIG. 1 is a diagram illustrating a schematic example of processing in the system that implements the advertisement transmission device of the present disclosure.

In FIG. 1, the traffic light is communicably connected to a server 10 and the terminal device of a moving body C1. Although one car is illustrated in FIG. 1 as a moving body connected to the traffic light serving as an advertisement transmission device, the types of and the number of moving bodies are not limited to this example.

A traffic light T1 captures an image of a road targeted by the traffic light T1. The traffic light acquires an image obtained by a camera installed around the traffic light T1 imaging a road targeted by the traffic light T1. The image of the road targeted by the traffic light T1 includes an image of the moving body C1 on the road targeted by the traffic light T1. The traffic light T1 determines an advertisement to be transmitted based on the attribute information of the moving body C1 based on the image and the lighting state of the traffic light T1 itself. At this time, the traffic light serving as the advertisement transmission device may acquire advertisement data for causing the terminal device to output the advertisement from the server 10. The traffic light may store advertisement data. The traffic light transmits the determined advertisement to the moving body C1.

In this example, the traffic light may be a smart traffic light. The smart traffic light is a traffic light having a communication function and an imaging function. In the present disclosure, the traffic light is not limited to the smart traffic light.

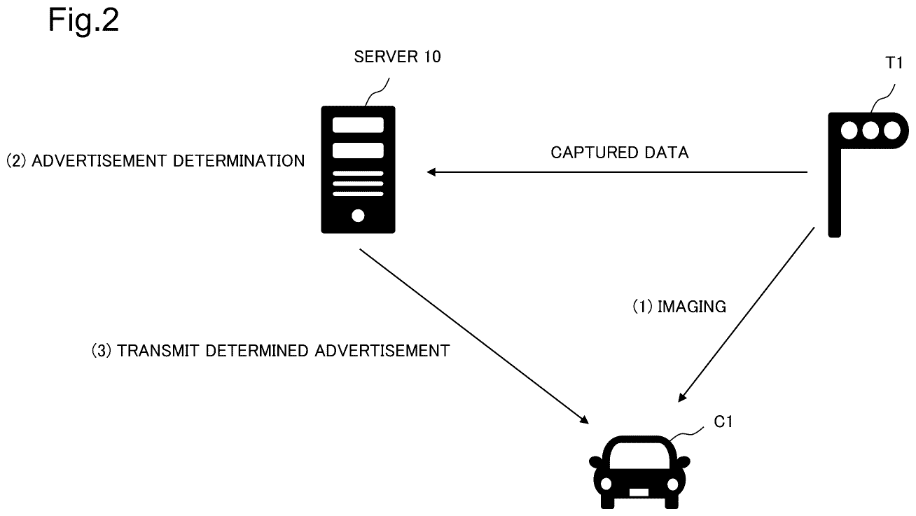

Next, FIG. 2 is a diagram illustrating another schematic example of processing in the system that implements the advertisement transmission device of the present disclosure.

In FIG. 2, the server 10 is communicably connected to the traffic light T1 and the terminal device of the moving body C1 on the road targeted by the traffic light T1. Similarly to the example in FIG. 1, one car is illustrated in FIG. 2 as a moving body connected to the server 10, but the types of and the number of moving bodies are not limited to this example.

The server 10 acquires an image obtained by a camera provided in the traffic light T1 or a camera installed around the traffic light T1 imaging the moving body C1 on the road targeted by the traffic light T1. The server determines an advertisement to be transmitted based on the attribute information of the moving body C1 based on the image and the lighting state of the traffic light T1 in which the image is captured. At this time, the server 10 may acquire advertisement data for causing the terminal device to output the advertisement from another server or a database (not illustrated). The server 10 may store the advertisement data. The server 10 transmits the determined advertisement to the moving body C1.

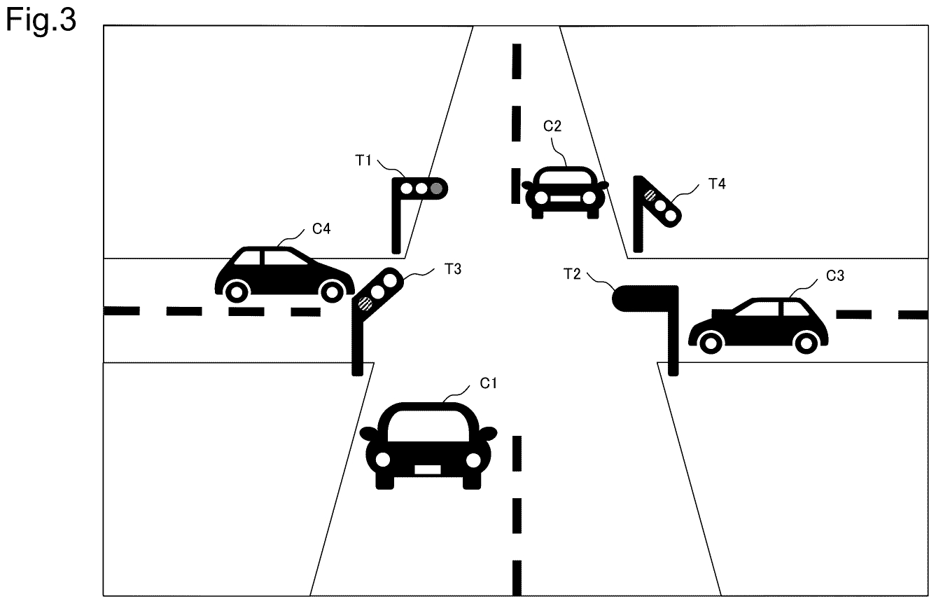

Here, a relationship among the advertisement transmission device, the traffic light, and the moving body will be described with reference to an example of a use scene of the advertisement transmission device in FIG. 3.

FIG. 3 is a diagram illustrating an example of an intersection where traffic lights are installed. A traffic light T1 performs lighting for traffic control targeting a moving body that approaches the traffic light T1 along a lane on the lighting side of the traffic light T1 on the lane including the moving body C1. Similarly, a traffic light T2 performs lighting for traffic control targeting a moving body that approaches the traffic light T2 along a lane on the lighting side of the traffic light T2 on the lane including the moving body C2. In FIG. 1, similarly to the traffic light T1 and the traffic light T2, a traffic light T3 and a traffic light T4 for a lane including a moving body C3 and a lane including a moving body C4, respectively, are installed for each lane.

The advertisement transmission device transmits an advertisement for each traffic light. For example, the advertisement transmission device acquires the attribute information of the moving body on the road targeted by each of the traffic light T1, the traffic light T2, the traffic light T3, and the traffic light T4 and the lighting state of each of the traffic lights T1 to T4, and transmits the advertisement based on the attribute information of the moving body on the road targeted by each traffic light and the lighting state of each traffic light. The advertisement transmission device may acquire the attribute information of the moving body on the road targeted by each of the traffic light T1 and the traffic light T2, and transmit the advertisement based on the attribute information of the moving bodies and the lighting states of the traffic lights. This is because the traffic light T1 and the traffic light T2 target oncoming lanes on the same road, and thus the lighting states of the traffic lights may be the same. In this case, similarly to the traffic light T1 and the traffic light T2, the advertisement transmission devices may transmit the advertisements at the traffic light T3 and the traffic light T4. In a case where the intersection where the traffic lights are installed is of the pedestrian-vehicle separation type, there is a case where it is a timing at which the lighting states of the traffic lights for the vehicle are all the same, that is, a state where all the lighting states of the traffic lights for the vehicle at the intersection indicate a stop. In this case, the advertisement transmission devices may acquire images of roads targeted by the traffic lights T1 to T4 and transmit advertisements based on attribute information of the moving bodies C1 to C4 based on the images of the roads.

In the example of FIG. 3, the road has one lane in each direction, but the number of lanes is not limited thereto. In the example of FIG. 3, the traffic light is illustrated to have three lights for the vehicle, that is, lamps of three colors: green, yellow, and red, but the type of traffic light is not limited thereto. For example, the traffic light may include a light displaying an arrow, or may include two lights for pedestrians.

Next, the example embodiment of the present disclosure will be described in detail with reference to the drawings.

### First Example Embodiment

A configuration of an advertisement transmission device 100 according to a first example embodiment will be described in detail.

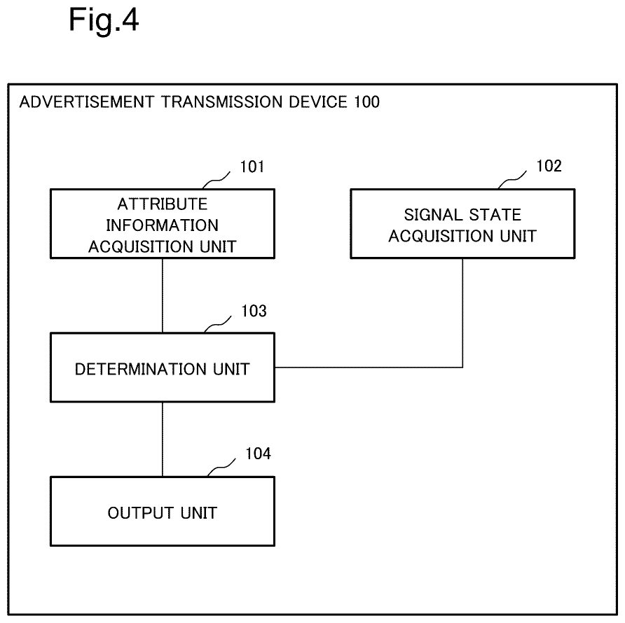

FIG. 4 is a block diagram illustrating the configuration of the advertisement transmission device 100 according to the first example embodiment. Referring to FIG. 2, the advertisement transmission device 100 includes an attribute information acquisition unit 101, a lighting state acquisition unit 102, a determination unit 103, and an output unit 104.

In FIG. 4, the attribute information acquisition unit 101 is an example of an attribute information acquisition means for acquiring attribute information of a moving body detected from an image of a road targeted by a traffic light and imaged by the traffic light that displays the traffic signal for the moving body traveling on the road. The attribute information of the moving body is information indicating the attribute of the moving body, estimated based on the image of the road targeted by the traffic light. As the attribute information of the moving object, an item assumed to be related to the attribute of the occupant of the moving body or the attribute of the pedestrian is only required to be used.

For example, the attribute information acquisition unit 101 may acquire the attribute information of the moving body from another server that estimates the attribute information based on the image of the road targeted by the traffic light. The attribute information acquisition unit 101 may acquire the image of the road targeted by the traffic light, and estimate the attribute information of the moving body from the acquired image.

Here, the image of the road targeted by the traffic light is captured by a camera provided in the traffic light or a camera provided around the traffic light. The image of the road targeted by the traffic light is only required to be an image including a lane targeted by the traffic light. The image of the road or the lane includes a road or a lane including at least a plurality of vehicles that are stopped in response to the traffic light and arranged in a traveling direction. For example, the image of the road is an image covering a range including about 20 vehicles arranged in the traveling direction, but the range of the image is only required to be appropriately determined.

An example of a method for estimating the attribute information of the moving body will be described. The attribute information acquisition unit 101 may estimate the attribute information of the moving body based on the detection result of the moving body detected from the image of the road. An example of estimation processing in this case will be described. First, the attribute information acquisition unit 101 extracts an image covering a range targeted by the traffic light from the image of the road. For example, the attribute information acquisition unit 101 identifies, from the image of the road including the oncoming lane, a lane targeted by the traffic light, that is, a range of a lane on a side facing the traffic light. The attribute information acquisition unit 101 detects the moving body by image recognition in the range identified from the image. The attribute information acquisition unit 101 classifies each of the detected moving bodies. The classification of the moving body may be, for example, a classification of an automobile, a motorcycle, a bicycle, and a pedestrian. The attribute information acquisition unit 101 estimates the attribute information for each of the classified moving bodies from the features of the image.

Here, an example of the attribute information of the moving body and a method for estimating the attribute information will be described for each classification of the moving bodies described above.

First, the attribute information of the automobile may include a vehicle type, a vehicle category, a manufacturer, a vehicle class, a seating capacity, a vehicle color, a regional indication, and information regarding whether the vehicle is for commercial or private use. For example, the attribute information acquisition unit 101 may identify the vehicle type from the image by collating the images or by using a trained model trained using the vehicle model and an image of the automobile of that model as training data. In a case where the vehicle type is identified, the attribute information acquisition unit 101 may acquire the vehicle category, the manufacturer, the vehicle class, and the seating capacity, which are stored in association with the vehicle type in advance. The vehicle category is only required to be classified based on a target user group or an intended use of the automobile. For example, the vehicle category may be a family car, a compact car, a sports car, or the like. The attribute information acquisition unit 101 may identify the color of the automobile from the pixel information of the image of the detected moving body. The attribute information acquisition unit 101 may perform character recognition on the license plate from the image of the detected moving body to identify the regional indication and whether the vehicle is for commercial or private use.

Next, the attribute information of the motorcycle may indicate a vehicle type, a manufacturer, a vehicle class type, the number of occupants, a regional indication, and the like. For example, as in the case of the automobile, the attribute information acquisition unit 101 may identify the vehicle type from the image by collating the images or by using a trained model trained using the vehicle type and an image of the motorcycle of that type as training data. In a case where the vehicle type is identified, the attribute information acquisition unit 101 may acquire the vehicle category, the manufacturer, and the vehicle class, which are stored in association with the vehicle type in advance. In a case where the moving body is the motorcycle, the vehicle category may be a large-sized or medium-sized category. The attribute information acquisition unit 101 may identify the number of occupants actually riding on the motorcycle from the image. As in the case of the automobile, the attribute information acquisition unit 101 may identify the color of the motorcycle or the regional indication of the license plate from the image.

Next, the attribute information of the bicycle may indicate a vehicle category, a manufacturer, and the number of occupants. The attribute information of the bicycle may also include the type of bicycle. In a case where the moving body is the bicycle, the vehicle category may include categories such as a road bike, a mountain bike, a cross bike, a city cycle, an electrically assisted bicycle, a folding bicycle, a mini velo, a bicycle with a child seat, and a children's bicycle. The attribute information acquisition unit 101 may identify the vehicle category from the image based on features such as the handlebar, the characteristics of the frame and tires, and the presence or absence of a basket or gears. As in the case of the automobile, the attribute information acquisition unit 101 may identify the vehicle category from the image by collating the images or by using a trained model trained using the vehicle category and an image of the bicycle of that category as training data. The attribute information acquisition unit 101 may identify the manufacturer of the bicycle from the logo included in the image. As in the case of the motorcycle, the attribute information acquisition unit 101 may identify the number of occupants actually riding on the motorcycle, the color, and the regional indication of the license plate from the image.

Regarding the image of the motorcycle or bicycle, in a case where a plurality of the motorcycles or bicycles are included, whether or not the motorcycles or the bicycles form a group unit may be estimated as the attribute information based on a distance between the motorcycles or between the bicycles. For example, in a case where the distance between the motorcycles or between the bicycles is smaller than a predetermined value, the attribute information acquisition unit 101 may regard the motorcycles or the bicycles as a group unit. In a case where the motorcycles or the bicycles form a group unit, it is estimated that the motorcycles or the bicycles are traveling over a long distance.

Next, the attribute information of the pedestrian may indicate gender, age, presence or absence of a walking aid or a mobility aid. The walking aid is a device that assists the pedestrian in walking, and may include a walking stick or a wheeled walker. The mobility aid is a device that assists the pedestrian in travelling, and may include a wheelchair or a stroller. The attribute information acquisition unit 101 may identify the attribute information of the pedestrian using a trained model trained using the attribute information of the pedestrian and the image of the pedestrian. The attribute information of the pedestrian may include information regarding whether or not the pedestrians form a group or attribute information of the group. The attribute information acquisition unit 101 may estimate whether or not the pedestrians form a group based on the distance between the pedestrians. The attribute information acquisition unit 101 may estimate the attribute information of the group using the attribute information of each pedestrian. For example, in a case where a group of pedestrians includes a child and an adult, the group may be estimated to be a family.

The attribute information acquisition unit 101 may estimate the attribute information of the occupant of the moving body or the attribute information of the pedestrian based on the attribute information of the moving body identified from the image described above. The attribute information acquisition unit 101 may estimate the attribute information related to the content of the advertisement based on the attribute information of the moving body as the attribute information of the occupant of the moving body or the attribute information of the pedestrian. The attribute information related to the content of the advertisement may be, for example, a classification such as a family group, going away, working, or the like. The attribute information of the occupant of the moving body or the attribute information of the pedestrian is only required to be associated with the attribute information of each moving body.

In a case where the moving body is not included in the image of the road targeted by the traffic light, the attribute information acquisition unit 101 may acquire or detect information indicating that the moving body is not included in the image of the road targeted by the traffic light.

Next, the lighting state acquisition unit 102 is an example of a lighting state acquisition means for acquiring information indicating the lighting state of the traffic light. The lighting state acquisition unit 102 may acquire the information indicating the lighting state of the traffic light from another server that detects the lighting state of the traffic light or from a control device that controls the lighting state of the traffic light. The lighting state acquisition unit 102 may detect the lighting state of the traffic light by using an image obtained by imaging the traffic light or control information of the traffic light.

Here, the traveling and stopping of the moving body on the road are controlled based on the lighting state of the traffic light. The lighting state of the traffic light represents the lighting color of the traffic light, the presence or absence of an arrow lighting in the traffic light, blinking of the traffic light, or a combination thereof with respect to the moving body, and thus the traveling of the moving body on the road is controlled. The lighting state of the traffic light includes, for example, a state where the moving body is instructed to stop, a state indicating that the moving body can travel, a state indicating that the moving body can travel in the direction indicated by the arrow, a state indicating that the moving body can travel carefully, and a state where the moving body is instructed to travel after temporarily stopping. The lighting state of the traffic light may not include a state indicating that the moving body can travel, a state indicating that the moving body can travel carefully, a state where the moving body travels after temporarily stopping, and a state where the moving body is instructed to stop. In a case where the lighting state of the traffic light is a state indicating that the moving body can travel in the direction indicated by the arrow, the lane for traveling in the direction indicated by the arrow may not be in a state where the moving body is instructed to stop. On the other hand, in a case where the lighting state of the traffic light is a state indicating that the moving body can travel in the direction indicated by the arrow, the lighting state of the traffic light for the lane in which the moving body does not travel in the direction indicated by the arrow may be the state where the moving body is instructed to stop. The information indicating the lighting state of the traffic light may include not only the information indicating the state at a time when the traffic light lights up but also a timing when the lighting state of the traffic light changes and the information indicating the lighting state after the lighting state changes at the timing. For example, the information indicating the lighting state of the traffic light may include not only the information indicating that the red light currently signals the stop but also the information indicating that the state changes from the red light to the blue light after one minute and the moving body can travel.

A method in which the lighting state acquisition unit 102 detects the lighting state of the traffic light will be described.

An example of the method for detecting the lighting state of the traffic light will be described. For example, the lighting state acquisition unit 102 may detect the lighting state of the traffic light based on the image of the traffic light. The image of the traffic light is an image including a lighting side of the traffic light. The image of the traffic light may be, for example, an image captured by a camera provided on a road or a camera provided in a moving body traveling on the road. The lighting state acquisition unit 102 may acquire an image of the traffic light from the camera or a terminal device connected to the camera.

For example, the lighting state acquisition unit 102 may collate the acquired image of the traffic light with various images showing the lighting states of the traffic lights, and detect the lighting state corresponding to the matching image as the lighting state of the traffic light. For example, the lighting state acquisition unit 102 may compare the pixel information of the lighting surface in the acquired image of the traffic light with the pixel information indicating various lighting states, and detect the lighting state corresponding to the pixel information within the range of the numerical value as the lighting state of the traffic light.

For example, in a case where the time interval and the order of light switching of the traffic light are determined in advance, the lighting state acquisition unit 102 may detect the next lighting state and the time at which the lighting state is switched to the next lighting state based on the lighting state detected from the acquired image, the time at which the state is switched to this lighting state, and a predetermined time interval.

The lighting state acquisition unit 102 may detect the time at which the state of the traffic light is switched to the next lighting state by detecting the lighting states of other traffic lights whose lighting states are switched in coordination. The other traffic lights whose lighting states are switched in coordination are, for example, pedestrian traffic lights on the same road, traffic lights on the intersecting roads, or pedestrian traffic lights on intersecting roads. For example, in a case where it is detected that the green lamp of the pedestrian traffic light on the same road starts blinking, the lighting state acquisition unit 102 can detect that the lighting state of the traffic light turns yellow after a predetermined time and further that the lighting state of the traffic light turns red after a predetermined time.

Another example of the method for detecting the lighting state of the traffic light will be described. This example is an example of estimating the lighting state of the traffic light instead of detecting the lighting state of the traffic light. For example, the lighting state acquisition unit 102 may estimate the lighting state of the traffic light based on the image of the road targeted by the traffic light. The image of the road targeted by the traffic light may be an image used by the attribute information acquisition unit 101 to estimate the attribute information. The lighting state acquisition unit 102 may estimate the lighting state of the traffic light based on the speed of the moving body detected from the image. For example, in a case where the speed of the car detected from the image is low, the lighting state acquisition unit 102 may estimate that the lighting state of the traffic light turns yellow, that is, the lighting state of the traffic light turns red after several seconds. In a case where the pedestrian detected from the image stops, the lighting state acquisition unit 102 may estimate that the lighting state of the traffic light turns red after several seconds. For example, in a case where the car detected from the image stops, the lighting state acquisition unit 102 may estimate that the lighting state of the traffic light is red.

In this case, the lighting state acquisition unit 102 detects that the speed of the car is reduced and that the car is stopped. The lighting state acquisition unit 102 may detect that the deceleration of the car, the traveling at a low speed of the car, or the stop of the car, and detect that traffic congestion occurs on the road by using the lighting state of the traffic light. For example, the lighting state acquisition unit 102 detects that traffic congestion occurs on the road based on the lighting state indicating that the moving body can travel and the detection of the deceleration of the car, the traveling at a low speed of the car, or the stop of the car on the road targeted by the traffic light. Still another example of the method for detecting the lighting state of the traffic light will be described. The lighting state acquisition unit 102 may acquire control information for controlling the lighting state of the traffic light and detect the lighting state of the traffic light based on the control information. In a case where the control system of the traffic light performs fixed-cycle control in which the parameters of signal control are set in advance according to time periods, the control information of the traffic light may be the parameters of the signal control. In a case where the control system of the traffic light performs actuated control, the control information of the traffic light may be information used for the actuated control.

Next, the determination unit 103 is an example of a determination means for determining an advertisement to be transmitted to the terminal device of the moving body based on the lighting state of the traffic light and the attribute information of the moving body estimated from the image. The determination unit 103 determines whether or not to transmit an advertisement, and determines the timing of transmitting the advertisement, the form of the advertisement, and the content of the advertisement based on the lighting state of the traffic light and the attribute information of the moving body estimated from the image. First, among methods in which the determination unit 103 determines an advertisement based on the lighting state of the traffic light and the attribute information, a method in which the determination unit 103 determines whether or not to transmit an advertisement and determines the timing of transmitting the advertisement and the form of the advertisement will be described. First, the determination unit 103 determines whether or not to transmit the advertisement. In a case where it is determined to transmit the advertisement, the determination unit 103 determines the timing of transmitting the advertisement and the form of the advertisement. In a case where it is not determined to transmit the advertisement, the determination unit 103 may not determine the timing of transmitting the advertisement and the form of the advertisement.

The determination unit 103 determines whether or not to transmit an advertisement and determines the timing of transmitting the advertisement and the form of the advertisement according to the lighting state of the traffic light in such a way as not to distract the attention of the occupant of the moving body or the attention of the pedestrian during the movement. In the determination of whether or not to transmit the advertisement, the timing of transmitting the advertisement, and the form of the advertisement, it is possible to maintain the safety during the traveling of the moving body by performing the determination in such a way as not to distract the attention of the occupant of the moving body or the attention of the pedestrian during the movement.

A method in which the determination unit 103 determines whether or not to transmit an advertisement and determines, the timing of transmitting the advertisement, and the form of the advertisement will be described.

First, a method in which the determination unit 103 determines whether or not to transmit an advertisement will be described.

The determination unit 103 may determine whether or not to transmit an advertisement according to the presence or absence of the moving body detected from the image of the road targeted by the traffic light. For example, in a case where the moving body is not detected from the image of the road targeted by the traffic light, the determination unit 103 may determine not to transmit the advertisement. The determination unit 103 acquires the image of the road targeted by the traffic light. The image of the road targeted by the traffic light may be acquired from a camera that captures an image at the traffic light or a server that collects and stores the images from the camera. In a case where the attribute information acquisition unit 101 acquires the image and estimates the attribute, the determination unit 103 may detect the presence or absence of the moving body detected from the image of the road using the same image. In a case where the attribute information acquisition unit 101 acquires information indicating the presence or absence of the moving body detected from the image of the road, the determination unit 103 may determine whether or not to transmit the advertisement according to the information indicating the presence or absence of the moving body.

The determination unit 103 may determine whether or not to transmit the advertisement according to the lighting state of the traffic light. For example, in a case where the lighting state of the traffic light is a state indicating stop, the determination unit 103 determines to transmit the advertisement. The determination unit 103 may determine not to transmit the advertisement in a case where the lighting state is not a state indicating stop.

Next, a method in which the determination unit 103 determines the timing of transmitting an advertisement will be described.

In a case where the determination unit 103 determines the timing of transmitting the advertisement, the determination unit 103 determines the timing of transmitting the advertisement according to the lighting state of the traffic light. For example, at the time when the lighting state of the traffic light is a state indicating stop, the determination unit 103 determines to transmit the advertisement.

In this case, the determination unit 103 may determine the timing of transmitting the advertisement based on the image of the road targeted by the traffic light in addition to the lighting state of the traffic light. For example, the determination unit 103 may determine to transmit the advertisement at a timing when the moving body included in the image is stopped. Here, the timing at which the moving body included in the image is stopped may be a case where the moving body is stopped due to the traffic congestion on the road in addition to a case where the moving body is stopped in response to the lighting state of the traffic light.

Next, a method in which the determination unit 103 determines the form of the advertisement will be described.

In a case where the determination unit 103 determines the form of the advertisement to be transmitted, the determination unit 103 may determine the form of the advertisement according to the lighting state of the traffic light.

For example, the form of the advertisement indicates the presence or absence of screen display. The screen display of the advertisement is to display an image including a video of the advertisement, text, and the like on the display unit of the terminal device. In this case, the determination unit 103 determines the presence or absence of the screen display of the advertisement according to the lighting state of the traffic light. For example, in a case where the lighting state of the traffic light is a state indicating stop, the determination unit 103 may determine the advertisement including the screen display as an advertisement to be transmitted to the terminal device of the moving body. For example, in a case where the lighting state of the traffic light is not a state indicating stop, the determination unit 103 may determine the advertisement not including the screen display as an advertisement to be transmitted to the terminal device of the moving body. Here, the advertisement not including the screen display may be a voice-based advertisement. Since the transmitted advertisement does not include the screen display, it is possible to reduce the possibility that the advertisement distracts the visual attention of the occupant of the moving body or the visual attention of the pedestrian.

For example, the form of the advertisement may be a notification for confirming whether or not to output the advertisement. For example, in a case where the lighting state of the traffic light is not the state indicating stop, the determination unit 103 may determine to transmit, to the terminal device, a notification for causing the terminal device to select whether or not to output the advertisement.

The determination unit 103 may determine the length of the advertisement as the form of the advertisement according to the lighting state of the traffic light. The length of the advertisement is the duration of video or audio which is the advertisement. For example, the determination unit 103 may determine, as the upper limit of the length of the advertisement, the duration during which the state indicating stop of the moving body identified from the lighting state of the traffic light continues. For example, the determination unit 103 may determine, as the upper limit of the length of the advertisement, the duration from the timing of the advertisement transmission until the state changes to the state not indicating the stop of the moving body identified from the lighting state of the traffic light.

As described above, the determination unit 103 determines at least one of whether or not to transmit an advertisement, a timing to transmit the advertisement, or a form of the advertisement in such a way as to maintain the safety of the moving body.

Next, among methods in which the determination unit 103 determines an advertisement based on the lighting state of the traffic light and the attribute information, a method in which the determination unit 103 determines the content of the advertisement will be described.

The determination unit 103 determines the content of the advertisement based on the attribute information of the moving body. The determination unit 103 determines the content of the advertisement based on the attribute information of the moving body included in the image of the road targeted by the traffic light. For example, the determination unit 103 may determine, as the content of the advertisement to be transmitted, the content of the advertisement suitable for the most frequently included attribute information among pieces of the attribute information of the moving bodies included in the image of the road targeted by the traffic light. In a case where the attribute information of the occupant of the moving body or the attribute information of the pedestrian is included, the determination unit 103 may determine, as the content of the advertisement to be transmitted, the content of the advertisement suitable for the most frequently included attribute information among pieces of the attribute information of the occupants of the moving bodies or the pedestrians, which are included in the image of the road targeted by the traffic light. For example, in a case where there are a plurality of pieces of attribute information of the moving bodies on the road targeted by the traffic light, the determination unit 103 may determine, as the content of the advertisement to be transmitted, an advertisement for a family restaurant or a toy for children for a family group with the most frequent attribute among a plurality of pieces of the attribute information. In a case where a plurality of advertisements are transmitted, in addition to the advertisement having the content suitable for the most frequent attribute information among pieces of the attribute information of a plurality of moving bodies, an advertisement having the content suitable for the second most frequent attribute information may be determined as the content of the advertisement to be transmitted. For example, the determination unit 103 may determine, as the content of an advertisement to be transmitted, an advertisement for a family restaurant or a toy for children for a family group with the most frequent attribute information among pieces of attribute information of a plurality of moving bodies on the road targeted by the traffic light, and an advertisement for a tourist destination for a tourist with the second most frequent attribute information.

Here, for example, the content of the advertisement is for promoting a facility such as a store. The facility is, for example, a nearby facility. The content for promoting the facility may be, for example, a description of the facility or sale products and special offer information in a case where the facility is a store. The content of the advertisement may include coupon information related to use of the facility. In this case, the advertisement may include guidance information to a facility to be advertised. The guidance information to the facility may include a distance from the traffic light to the facility, a turning direction, and a position of an intersection. In this case, the advertisement may include an operation object for starting the guidance to a facility to be advertised. The operation object for starting the guidance to a facility to be advertised may be a button on the screen or an operation object for selecting using voice recognition. For example, when the operation object for starting guidance to a facility is selected, the terminal device causes an application performs navigation of the terminal device to start guidance with the facility as a destination.

In a case where the content of the advertisement is the content for promoting the facility, the determination unit 103 may determine the content of the advertisement according to the traveling direction of the moving body on the road targeted by the traffic light. For example, the determination unit 103 may determine an advertisement including information regarding a facility located in the traveling direction of the moving body targeted by the traffic light as an advertisement to be transmitted to the terminal device of the moving body.

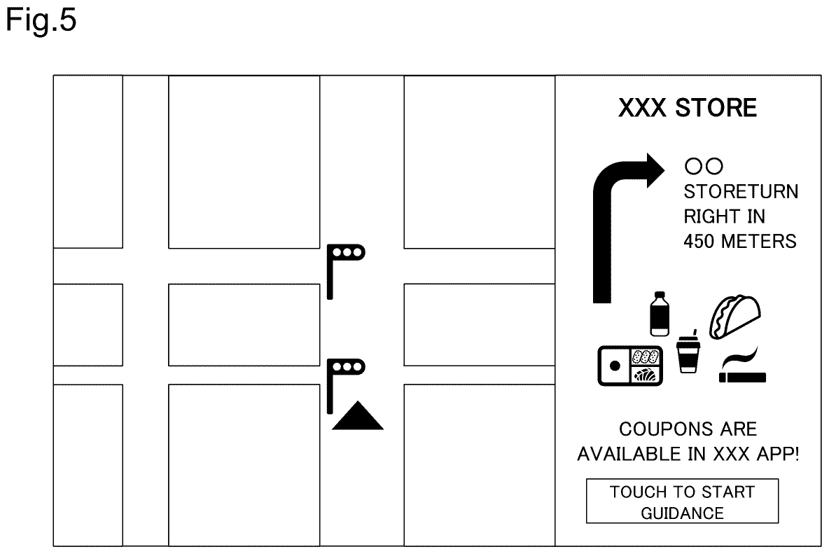

FIG. 5 is an example of the advertisement output screen. The output screen example of FIG. 5 is an example in which an advertisement screen is output to a part of the navigation system. In FIG. 5, the advertisement is the content for promoting “XXX store branch ○○branch” as a facility. The output screen example in FIG. 5 includes, as the guidance information to the facility, an arrow indicating a direction toward the facility's location and text indicating the route to the facility's location such as “Turn right in 450 meters”. The output screen example in FIG. 5 is the advertisement for the facility located in the traveling direction of the moving body described above. The output screen example in FIG. 5 includes an introduction of sale products using an image, “Coupons are available in XXX app!”, which is text to promote a facility's application, and “Touch to start guidance” indicating an operation object for starting the guidance to the facility. The advertisement output screen example in FIG. 5 is an example, and the present disclosure is not limited thereto. For example, the advertisement may be an image superimposed on a real-world image or view on a windshield on which the image is displayed via an augmented reality space using a camera function of the terminal device, smart glasses, or a terminal device provided in a car, or the like.

The content of the advertisement is not limited to the promotion of the facility, and may be a traffic light, a place-limited advertisement that can be viewed only within a certain range, or the like. As the content of the advertisement, a check-in function on the terminal for that location may be provided. This is only required to be an advertisement in cooperation with the application of the terminal device that can obtain a coupon or a place-limited advertisement by performing this check-in at one or more designated places. According to such an advertisement, for example, an increase in the number of visitors to the area is expected.

Next, the output unit 104 is an example of an output means for outputting the determined advertisement to the terminal device of the moving body on the road targeted by the traffic light. For example, the output unit 104 may output the advertisement to the traffic light or a directional antenna installed around the traffic light, and cause the directional antenna to transmit the advertisement to the road targeted by the traffic light.

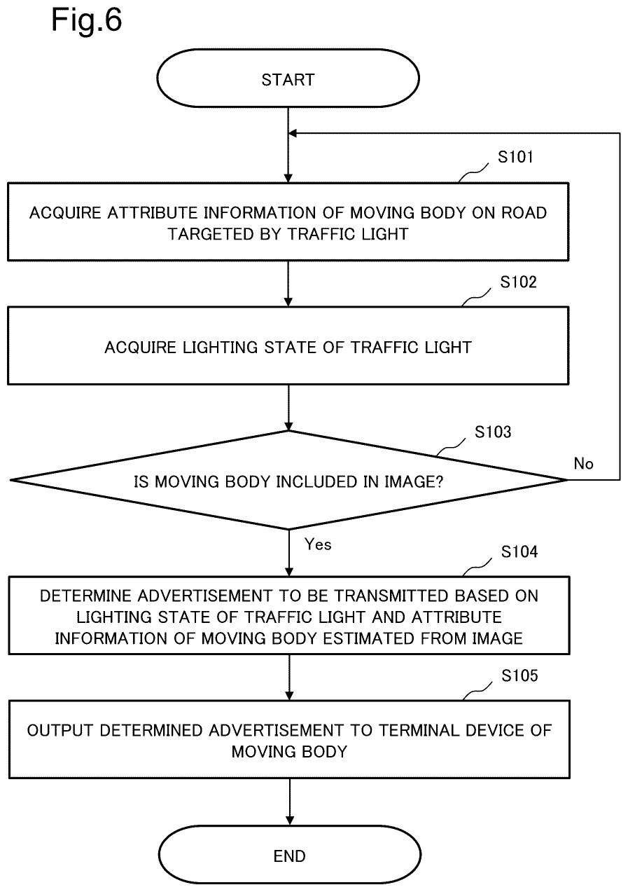

An example of the operation of the advertisement transmission device 100 configured as described above will be described with reference to a flowchart of FIG. 6.

As illustrated in FIG. 6, first, the attribute information acquisition unit 101 acquires attribute information of a moving body on a road targeted by a traffic light based on an image of the road targeted by the traffic light (step S101).

Next, the lighting state acquisition unit 102 acquires the lighting state of the traffic light (step S102).

Next, the determination unit 103 determines whether or not to transmit an advertisement according to whether or not the moving body is included in the image of the road targeted by the traffic light (step S103). In a case where the moving body is not included in the image in step S103 (step S103: No), the determination unit 103 determines not to transmit the advertisement, and the processing of the advertisement transmission device 100 returns to step S101.

In a case where the moving object is included in the image in step S103 (step S103: Yes), the determination unit 103 determines an advertisement to be transmitted based on the lighting state of the traffic light and the attribute information of the moving body estimated from the image (step S104).

The output unit 104 outputs the advertisement determined in step S104 to the terminal device of the moving body (step S105).

As described above, the advertisement transmission device 100 ends a series of operations. The advertisement transmission device 100 may repeatedly execute the series of operations. For example, the advertisement transmission device 100 may perform the operations in step S101 and steps S103 to S105 according to the signal state. For example, the advertisement transmission device 100 may perform the operations in steps S102 to S105 according to the acquisition result of the attribute information. The order and timing of the processing in steps S101 and S102 are not limited to this example.

In the advertisement transmission device according to the present example embodiment described above, the determination unit determines an advertisement to be transmitted to the terminal device of the moving body based on the lighting state of the traffic light and the attribute information of the moving body estimated from the image of the road targeted by the traffic light, and the output unit outputs the determined advertisement to the terminal device of the moving body on the road targeted by the traffic light.

As a result, the advertisement transmission device according to the present example embodiment can appropriately transmit the advertisement to a person traveling on the road.

In particular, the determination unit determines at least one of whether or not to transmit an advertisement, the timing of transmitting the advertisement, or the form of the advertisement based on the signal state, and thus the advertisement transmission device according to the present example embodiment can appropriately transmit the advertisement in consideration of the safety in the traveling of the moving body.

The determination unit determines the content of the advertisement based on the attribute information estimated from the image, and thus the advertisement transmission device according to the present example embodiment can increase the possibility of being able to transmit, to the occupant of the moving body or the pedestrian, the advertisement having the appropriate content corresponding to the occupant of the moving body or the pedestrian.

### Second Example Embodiment

Next, a second example embodiment of the present disclosure will be described in detail with reference to the drawings. Hereinafter, description of contents overlapping with the above description will be omitted to the extent that the description of the present example embodiment is not unclear.

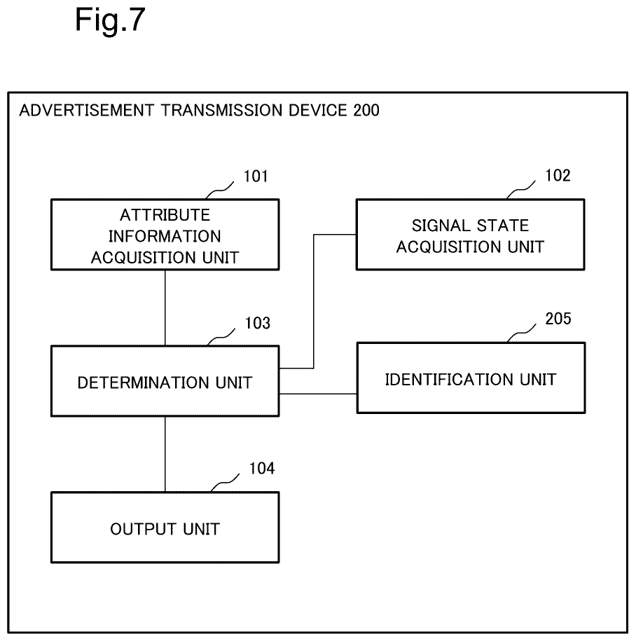

FIG. 7 is a block diagram illustrating a configuration of an advertisement transmission device 200 according to the second example embodiment of the present disclosure. The advertisement transmission device 200 according to the second example embodiment includes an identification unit 205 in addition to the configuration of the first example embodiment.

The identification unit 205 is an example of an identification means for identifying a terminal device of each moving body on the road targeted by the traffic light based on information obtained from the terminal device. Specifically, the identification unit 205 identifies a terminal device corresponding to each moving body included in the image of the road targeted by the traffic light.

An example of an identifying method of the identification unit 205 will be described. For example, the identification unit 205 identifies the terminal device of each moving body on the road targeted by the traffic light using the positional information of the terminal device. The identification unit 205 may acquire the positional information of the terminal device by communicating with the terminal device. In this case, first, the identification unit 205 acquires positional information indicating the position of the terminal device of the moving body. The identification unit 205 may identify, as the terminal device of the moving body, a terminal device in which the positional information of the terminal device of the moving body matches the positional information of the moving body included in the image estimated from the position of the moving body in the image of the road targeted by the traffic light.

For example, the identification unit 205 identifies the position of the moving body or the positional range by calculating the distance between the moving body on the image and the traffic light or the stop line. The identification unit 205 is only required to identify a terminal device whose positional information is closest to the identified position of the moving body or a terminal device whose positional information is included in the identified positional range of the moving body as the terminal device of the moving body.

In this case, the output unit 104 may cause the directional antenna to transmit an advertisement to the terminal device whose position is identified.

Another example of an identifying method of the identification unit 205 will be described. For example, the identification unit 205 identifies the terminal device of each moving body on the road targeted by the traffic light using the attribute information of the moving body associated with the identification information of the terminal device. In this case, first, the identification unit 205 acquires the identification information of the terminal device. The identification information of the terminal device may be membership registration information logged in to the terminal device. The identification information of the terminal device may be an identifier unique to the terminal device. For example, the identifier is an Internet Protocol (IP) address, but is not limited to this example. The identification unit 205 may acquire the attribute information of the moving body associated with the identification information of the terminal device from the acquired identification information of the terminal device. The attribute information of the moving body associated with the identification information of the terminal device may be stored in a device outside the advertisement transmission device 200. The attribute information of the moving body associated with the identification information of the terminal device is only required to be registered in advance by the user of the terminal device.

An example of using a membership registration information database provided inside or outside the advertisement transmission device will be described. For example, the membership registration information database stores features (vehicle type, color, and the like) of the moving body used by a member in association with member identification information for identifying the member. The identification unit 205 identifies the member identification information from the membership information database using the vehicle type and color of the car, which are the attribute information of the moving body.

In this case, the output unit 104 may transmit an advertisement to the terminal device that is logged in with the identified membership registration information or the application of the terminal device.

The determination unit 103 determines an advertisement to be transmitted to the terminal device of each moving body identified by the identification unit 205 based on the attribute information of each moving body estimated from the image. The output unit 104 transmits the determined advertisements to the identified terminal devices.

In a case where the identification unit 205 identifies the terminal device of the moving body using the membership registration information database, the determination unit 103 may determine the advertisement to be transmitted to the terminal device of the moving body by further using the attribute information stored in association with the membership registration information. For example, the determination unit 103 may determine the content of the advertisement to be transmitted to the terminal device of the moving body further based on the age, gender, preference information, purchase history, and the like of the occupant of the moving body or the pedestrian as the attribute information. The preference information is information indicating a hobby, interest, preference, and the like.

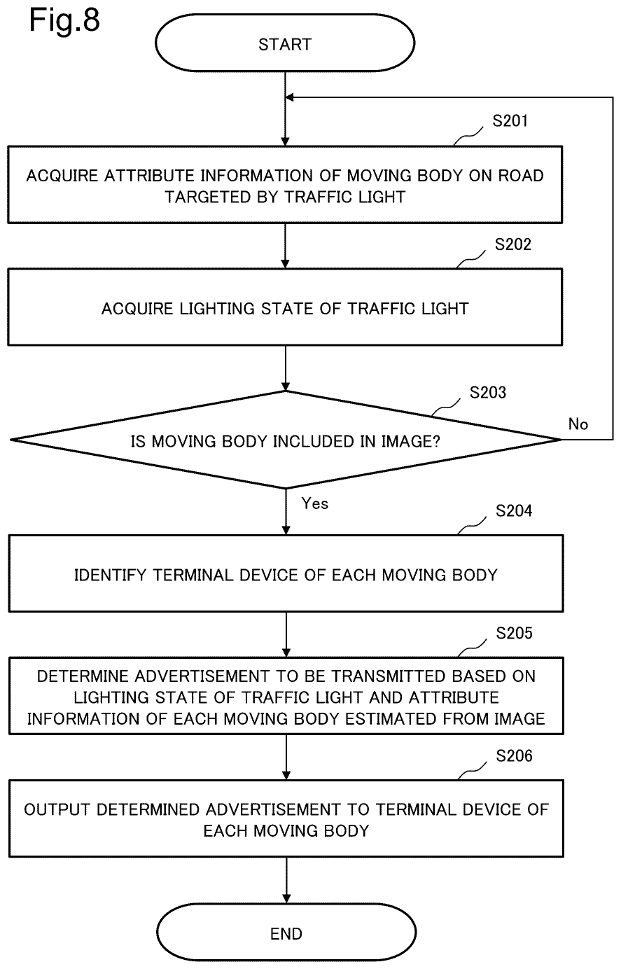

An example of the operation of the advertisement transmission device 200 configured as described above will be described with reference to a flowchart of FIG. 8.

As illustrated in FIG. 8, first, the attribute information acquisition unit 101 acquires the attribute information of the moving body based on the image of the road targeted by the traffic light (step S201).

Next, the lighting state acquisition unit 102 acquires the lighting state of the traffic light (step S202).

Next, the determination unit 103 determines whether or not to transmit the advertisement according to whether or not the moving body is included in the image of the road targeted by the traffic light (step S203). In a case where the moving body is not included in the image in step S203 (step S203: No), the determination unit 103 determines not to transmit the advertisement, and the processing of the advertisement transmission device 200 returns to step S201.

In a case where the moving body is included in the image in step S203 (step S203: Yes), the identification unit 205 identifies the terminal device of each moving body based on the information obtained from the terminal device (step S204).

Next, the determination unit 103 determines an advertisement to be transmitted for each terminal device of each moving body based on the lighting state of the traffic light and the attribute information of each moving body estimated from the image (step S205).

The output unit 104 outputs the advertisement determined in step S205 to the terminal device of each moving body (step S206).

As described above, the advertisement transmission device 200 ends a series of operations. The advertisement transmission device 200 may repeatedly execute the series of operations. For example, the advertisement transmission device 200 may perform the operations in step S201 and steps S203 to S206 according to the signal state. For example, the advertisement transmission device 200 may perform the operations in steps S202 to S206 according to the acquisition result of the attribute information. The order and timing of the processing in steps S201 and S202 are not limited to this example.

In the advertisement transmission device according to the present example embodiment described above, the identification unit identifies the terminal device of each moving body on the road targeted by the traffic light based on the information obtained from the terminal device. The determination unit determines an advertisement to be transmitted to the terminal device of each moving body based on the lighting state of the traffic light and the attribute information of each moving body estimated from the image of the road targeted by the traffic light, and the output unit outputs the determined advertisement to the terminal device of each moving body on the road targeted by the traffic light.

As a result, the advertisement transmission device according to the present example embodiment can appropriately transmit the advertisement to a person traveling on the road.

In particular, there are moving bodies with various attributes such as a family group, working, and sightseeing on the road targeted by the traffic light. That is, on the road targeted by the traffic light, the occupant of the moving body and the pedestrian, to which an advertisement is transmitted, have various different attributes. On the other hand, the identification unit identifies the terminal device of each moving body, and the determination unit determines the content of the advertisement to be transmitted to the terminal device of each moving body based on the attribute information of each moving body estimated from the image. Thus, the advertisement transmission device according to the present example embodiment can transmit, to the occupant of the moving body or the pedestrian, the advertisement having the appropriate content corresponding to each of the occupant of the moving body or the pedestrian.

### Hardware Configuration

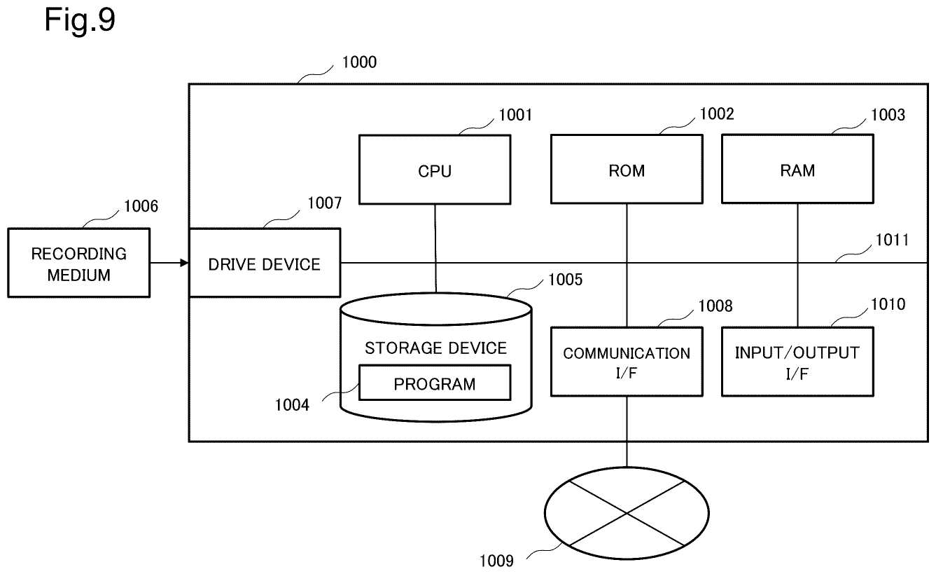

A part or all of components of each device or system in each example embodiment of the present disclosure described above is achieved by, for example, any combination of an information processing device 1000 and a program as illustrated in FIG. 9. As an example, the information processing device 1000 includes the following components.
A central processing unit (CPU) 1001
A read only memory (ROM) 1002
A random access memory (RAM) 1003
A program 1004 loaded into the RAM 1003
A storage device 1005 storing the program 1004
A drive device 1007 for reading a recording medium 1006
A communication I/F 1008 connected to a communication network 1009
An input/output I/F 1010 for inputting/outputting data
A bus 1011 connecting each component
I/F is an abbreviation of Interface.

Each component of each device or system in each example embodiment is achieved by the CPU 1001 acquiring and executing a program for achieving these functions. The program for achieving the function of each component of each device is stored in the storage device 1005 or the RAM 1003 in advance, for example, and is read by the CPU 1001 as necessary. The program 1004 may be supplied to the CPU 1001 via a communication network, or may be stored in advance in the recording medium 1006, and the drive device 1007 may read the program and supply the program to the CPU 1001.

There are various modification examples of the method for achieving each device. For example, each device or system may be achieved by any combination of the information processing device 1000 and the program separate for each component. A plurality of components included in each device may be achieved by any combination of one information processing device 1000 and the program.

Some or all of the components of each device or system are achieved by a general-purpose or dedicated circuit including a processor or the like, or a combination thereof. The circuit is, for example, a CPU, a graphics processing unit (GPU), a field programmable gate array (FPGA), or a large scale integration (LSI). The LSI is, for example, an LSI dedicated to artificial intelligence (AI) processing. These may be configured by a single chip or may be configured by a plurality of chips connected via a bus. Some or all of the components of each device may be achieved by a combination of the above-described circuit and the like and the program.

In a case where some or all of the components of each device or system are achieved by a plurality of the information processing devices, circuits, and the like, the plurality of information processing devices, circuits, and the like may be arranged in a centralized manner or in a distributed manner. For example, the information processing devices, the circuits, and the like may be achieved as a form in which each is connected via the communication network, such as a client-server system or a cloud computing system.

Although the present invention has been described with reference to each example embodiment, the present invention is not limited to the above example embodiments. Various modifications that can be understood by those skilled in the art can be made to the configuration and details of the present invention within the scope of the present invention.

Although a plurality of operations is described in order in the form of a flowchart, the order of description does not limit the order of executing the plurality of operations. Therefore, when each example embodiment is implemented, the order of the plurality of operations may be changed within a range that does not interfere with the content.

### REFERENCE SIGNS LIST

100 advertisement transmission device
101 attribute information acquisition unit
102 lighting state acquisition unit
103 determination unit
104 output unit
200 advertisement transmission device
205 identification unit
1000 information processing device
1001 CPU
1002 ROM
1003 RAM
1004 program
1005 storage device
1006 recording medium
1007 drive device
1008 communication I/F
1009 communication network
1010 input/output I/F
1011 bus
C1, C2, C3, C4 moving body
T1, T2, T3, T4 traffic light
10 server

What is claimed is:

1. An advertisement transmission device comprising:
one or more memories storing instructions; and
one or more processors configured to execute the instructions to:
acquire attribute information of a moving body detected from an image of a road targeted by a traffic light that displays a signal to the moving body traveling on the road, the image being captured by the traffic light;
acquire information indicating a lighting state of the traffic light;
determine an advertisement to be transmitted to a terminal device of the moving body based on the information indicating the lighting state of the traffic light and the attribute information; and
output the determined advertisement to the terminal device of the moving body on the road targeted by the traffic light.

2. The advertisement transmission device according to claim 1, wherein the one or more processors are further configured to execute the instructions to:
identify the terminal device of each moving body on the road targeted by the traffic light based on information obtained from the terminal device.

3. The advertisement transmission device according to claim 2, wherein the one or more processors are configured to execute the instructions to:
determine an advertisement to be transmitted to the identified terminal device of each moving body based on the attribute information of each moving body estimated from the image.

4. The advertisement transmission device according to claim 2, wherein the one or more processors are configured to execute the instructions to:
identify the terminal device of each moving body included in the image based on positional information indicating a position of the terminal device of the moving body.

5. The advertisement transmission device according to claim 1, wherein the one or more processors are configured to execute the instructions to:
determine whether or not the advertisement to be transmitted to the terminal device of the moving body includes screen display in accordance with the lighting state.

6. The advertisement transmission device according to claim 5, wherein the one or more processors are configured to execute the instructions to:
determine the advertisement including the screen display as the advertisement to be transmitted to the terminal device of the moving body in a case where the lighting state is a state indicating stop of the moving body, and determines the advertisement not including the screen display as the advertisement to be transmitted to the terminal device of the moving body in a case where the lighting state is not the state indicating the stop of the moving body.

7. The advertisement transmission device according to claim, wherein the one or more processors are configured to execute the instructions to:
determine whether or not to transmit the advertisement in accordance with the lighting state.

8. The advertisement transmission device according to claim 7, wherein the one or more processors are configured to execute the instructions to:
determine not to transmit the advertisement in a case where the lighting state is not a state indicating stop of the moving body.

9. The advertisement transmission device according to claim 1, wherein the one or more processors are configured to execute the instructions to:
detect the lighting state of the traffic light based on control information for controlling the lighting state of the traffic light.

10. The advertisement transmission device according to claim 1, wherein
the advertisement to be output includes guidance information to a facility to be advertised.

11. The advertisement transmission device according to claim 1, wherein the one or more processors are configured to execute the instructions to:
determine an advertisement including information regarding a facility located in a traveling direction of the moving body on the road targeted by the traffic light as the advertisement to be transmitted to the terminal device of the moving body.

12. The advertisement transmission device according to claim 1 wherein
the advertisement to be output includes an operation object for starting guidance to a facility to be advertised.

13. An advertisement transmission method comprising causing a computer to:
acquire attribute information of a moving body detected from an image of a road targeted by a traffic light that displays a signal to the moving body traveling on the road, the image being captured by the traffic light;
acquire information indicating a lighting state of the traffic light;
determine an advertisement to be transmitted to a terminal device of the moving body based on the information indicating the lighting state of the traffic light and the attribute information; and
output the determined advertisement to the terminal device of the moving body on the road targeted by the traffic light.

14. A non-transitory recording medium recording a program that causes a computer to execute processing of:
acquiring attribute information of a moving body detected from an image of a road targeted by a traffic light that displays a signal to the moving body traveling on the road, the image being captured by the traffic light;
acquiring information indicating a lighting state of the traffic light;
determining an advertisement to be transmitted to a terminal device of the moving body based on the information indicating the lighting state of the traffic light and the attribute information; and
outputting the determined advertisement to the terminal device of the moving body on the road targeted by the traffic light.
